(19) United States
(12) Patent Application Publication
(10) Pub. No.: US 2004/0105015 A1
(43) Pub. Date: Jun. 3, 2004

(54) Image processing device and image processing program

(75) Inventor: Taketo Tsukioka, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Optical Co., Ltd., Tokyo (JP)

(21) Appl. No.: 10/618,197

(22) Filed: Jul. 11, 2003

(30) Foreign Application Priority Data
Jul. 12, 2002 (JP) 2002-204364

(51) Int. Cl. H04N 5/235

(52) U.S. Cl. 348/222.1

(57) ABSTRACT

An image processing device according to the present invention comprises a combination average calculation processing unit for making a combination of two or more pixels from the multiple pixels having the same kind of the color component near the pixel of interest, and calculating the average for the color components of the two or more pixels making up the combination for multiple kinds of combinations of the pixels within the region near the pixel of interest, a color correlation estimation processing unit for estimating the color correlation which is a correlation between different kinds of color components near the pixel of interest, and a combination selection processing unit for selecting one of the multiple combination averages calculated by the aforementioned combination average calculation processing unit as the non-existent color component for the pixel of interest, based upon the color correlation estimated by the aforementioned color correlation estimation processing unit.

### CROSS-REFERENCE TO RELATED APPLICATION

This application claims benefit of Japanese Application No. 2002-204364 filed in Japan on Jul. 12, 2002, the contents of which are incorporated by this reference.

### BACKGROUND OF THE INVENTION

1. Field of the Invention

The present invention relates to an image processing device and an image processing program for generating color digital images.

2. Description of the Related Art

With the single-sensor image-pickup system employed in digital cameras or the like, a single-sensor image-pickup device wherein a different color filter is mounted on each pixel is employed, so the output image from the image-pickup device has only one color component for each pixel. Accordingly, a color digital image having tri-color components for each pixel is generated by performing color processing for generating the color information by estimating non-existent color component for each pixel. In the same way, with the double-sensor image-pickup system, or triple-sensor pixel spatial offset image-pickup system, there is also the need to perform color processing for estimation of non-existent color components for each pixel.

With this color processing, deterioration such as blurring or false colors, or the like, could be caused in a color image finally obtained, unless a suitable method is used. Accordingly, conventionally, various color processing methods have been proposed. The color processing can be roughly classified into two types; processing based upon edge detection, and processing based upon color correlation.

### SUMMARY OF THE INVENTION

An image processing device according to the present invention comprises: a combination average calculation unit for making a combination of two or more pixels from multiple pixels having the same color component near a pixel of interest and calculating the average for the combination of the color components of two or more pixels for multiple kinds of combinations of pixels in the region near the pixel of interest; a color correlation estimation unit for estimating color correlation which is a correlation between different color components within the region near the pixel of interest; and a combination selection unit for selecting one of the multiple combination averages calculated by the combination average calculation unit, as the non-existent color component for the pixel of interest, based upon the color correlation estimated by the color correlation estimation unit.

This feature and advantages of the present invention will become further apparent from the following detailed explanation.

### BRIEF DESCRIPTION OF THE DRAWINGS

FIG. 1 is a block diagram which illustrates a configuration of a digital camera according to a first embodiment of the present invention;

FIG. 2A is a diagram which illustrates a region near the pixel of interest used for the combination average generating circuit according to the aforementioned first embodiment;

FIG. 2B is a diagram which illustrates the region near the pixel of interest used for the color correlation calculation circuit according to the aforementioned first embodiment;

FIG. 3 is a flowchart which indicates the color correlation estimation processing performed by the color correlation calculation circuit according to the aforementioned first embodiment;

FIG. 4 is a flowchart which indicates the combination selection processing performed by the combination selection circuit according to the aforementioned first embodiment;

FIG. 5A is a diagram for describing an example of an edge and generated pixel value in the processing performed by the combination selection circuit according to the aforementioned first embodiment;

FIG. 5B is a diagram for describing an example of an edge and generated pixel value in the processing performed by the combination selection circuit according to the aforementioned first embodiment;

FIG. 6 is a flowchart which indicates the R/B generating processing performed by the R/B generating circuit according to the aforementioned first embodiment;

FIG. 7A is a diagram which illustrates an example of the region used for the processing performed by the R/B generating circuit according to the aforementioned first embodiment;

FIG. 7B is a diagram which illustrates another example of the region used for the processing performed by the R/B generating circuit according to the aforementioned first embodiment;

FIG. 8 is a flowchart which indicates the software processing performed by the computer according to the aforementioned first embodiment;

FIG. 9 is a block diagram which illustrates a configuration of a digital camera according to a second embodiment of the present invention;

FIG. 10 is a diagram for describing the processing performed by the combination average generating circuit according to the aforementioned second embodiment;

FIG. 11A is a diagram which illustrates the region used for the region judgment circuit according to the aforementioned second embodiment;

FIG. 11B is a diagram which illustrates the region used for the region judgment circuit according to the aforementioned second embodiment;

FIG. 11C is a diagram which illustrates the region used for the region judgment circuit according to the aforementioned second embodiment;

FIG. 12 is a flowchart which indicates the region judgment processing performed by the region judgment circuit according to the aforementioned second embodiment;

FIG. 13 is a flowchart which indicates the color correlation estimation processing performed by the color correlation calculation circuit according to the aforementioned second embodiment;

FIG. 14 is a flowchart which indicates the combination selection processing performed by the combination selection circuit according to the aforementioned second embodiment;

FIG. 15A is a flowchart which indicates the software processing performed by the computer according to the aforementioned second embodiment;

FIG. 15B is a flowchart which indicates the software processing performed by the computer according to the aforementioned second embodiment;

FIG. 16A is a diagram for describing color processing based upon conventional edge detection;

FIG. 16B is a diagram for describing color processing based upon conventional edge detection;

FIG. 16C is a diagram for describing color processing based upon conventional edge detection;

FIG. 17 is a diagram for describing color processing based upon conventional color correlation;

FIG. 18 is a diagram for describing color processing based upon conventional color correlation; and

FIG. 19 is a diagram for describing color processing based upon conventional color correlation.

The accompanying drawings, which are incorporated in and constitute a part of the specification, illustrate presently preferred embodiments of the invention, and together with the general description given above and the detailed description of the preferred embodiments given below, serve to explain the principles of the invention.

### DESCRIPTION OF THE PREFERRED EMBODIMENTS

Description will be made regarding the embodiments of the present invention with reference to the drawings.

In prior to the description of the invention, prerequisite technology for the invention will be described.

With the single-sensor image-pickup system employed in digital cameras or the like, a single-sensor image-pickup device wherein a different color filter mounted on each pixel is employed, so the output image from the image-pickup device has only one color component for each pixel. Accordingly, a color digital image is generated by performing color processing for generating the color information by estimating non-existent color component for each pixel. In the same way, with the double-sensor image-pickup system, or triple-sensor pixel spatial offset image-pickup system, there is the need to perform color processing for compensation due to the lack of color components for each pixel.

With the color processing, deterioration such as blurring or false colors, or the like, could be caused, unless a suitable method is used. Accordingly, conventionally, various color processing methods have been proposed. The color processing can be roughly classified into two types: processing based upon edge detection, and processing based upon color correlation.

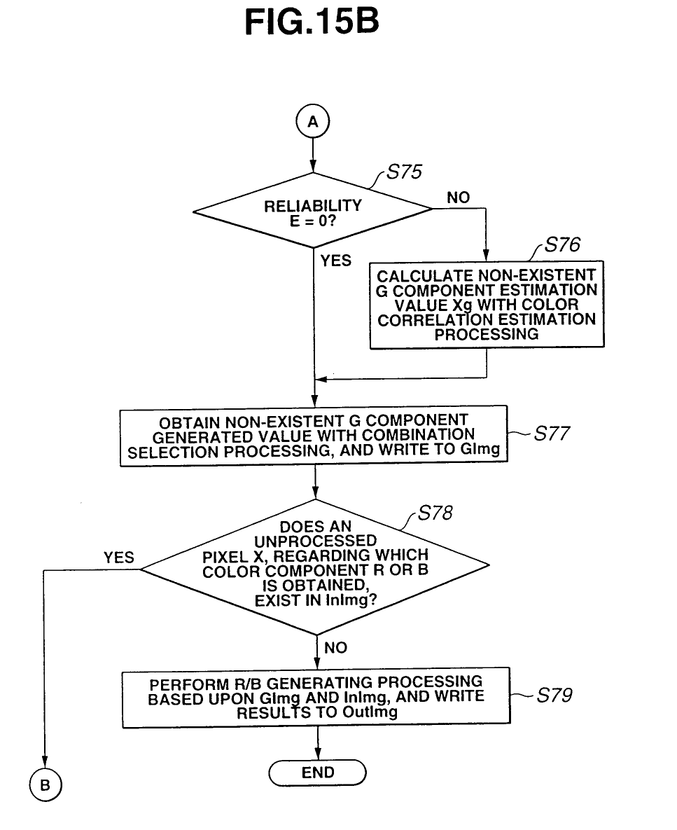

An example of the technique based upon edge detection is an arrangement disclosed in Japanese Unexamined Patent Application Publication No. 8-298669. Description will be made regarding the technique described in this Publication with reference to FIGS. 16A, 16B, and 16C. FIGS. 16A, 16B, and 16C are diagrams for describing color processing based upon conventional edge detection.

In a case that the single-sensor image-pickup device has primary-color Bayer-array color filters as shown in FIG. 16A, for example, with the pixel of interest X having the R component or B component (which is denoted by R0 in the example shown in the drawing), the difference between the G components of the left and right pixels thereof dH=|G2−G3| and the difference between the G components of the upper and lower pixels thereof dV=|G1−G4| are calculated, and the average of G components, aH=(G2+G3)/2 or aV=(G1+G4)/2, is calculated in the direction wherein the difference is smaller than the other, thereby estimating it as the G component non-existent in the pixel of interest X from the average, as described in FIG. 16B.

As described above, with the conventional technique based upon edge detection, the spatial correlation between pixels is obtained for multiple pixels having the same color component near the pixel of interest, and selects the combination of the pixels near the pixel of interest with high spatial correlation for the same color, thereby generating the same color component non-existent in the pixel of interest.

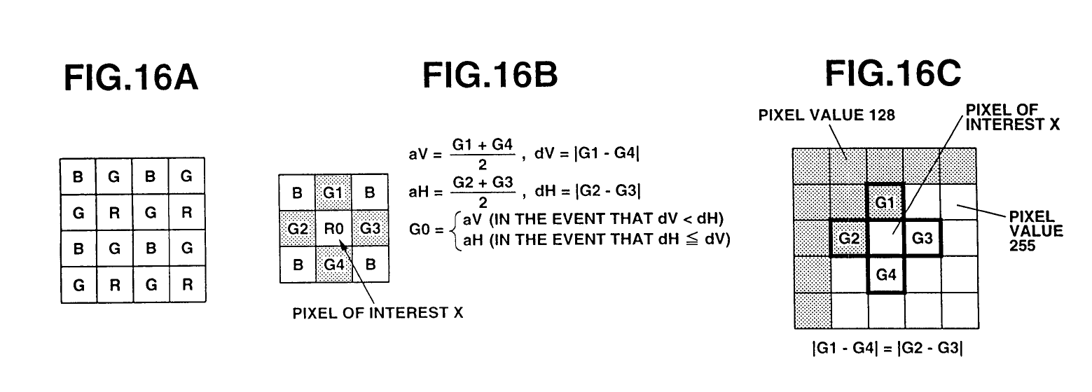

On the other hand, an example of the technique based upon color correlation is an arrangement disclosed in Japanese Unexamined Patent Application Publication No. 11-215512. Description will be made regarding the technique described in this Publication with reference to FIGS. 17 through 19. FIGS. 17 through 19 are diagrams for describing color processing based upon the conventional color correlation.

As shown in FIG. 17, first of all, let us say that a linear correlation holds between the color component values Vp and Vq of two given color components p and q formed by the color filters on the image-pickup device (e.g., in a case of the primary-color filters, the color components are r, g, and b) around the pixel of interest, as represented by Expression 1 using coefficients αqp and βqp.

Vq=αqp×Vp+βqp (1)

Subsequently, in the region U set around the pixel of interest X, the pixels within the region U are classified into three subsets Ur, Ug, and Ub, based upon the obtained color components r, g, and b, and the aforementioned coefficients αqp and βqp are estimated based upon the average Ac (c indicates r, g, or b), and the standard deviation Sc (c indicates r, g, or b) for the pixel values in each subsets, as shown in Expression (2).

αqp=Sq/Sp, βqp=Aq−αqp×Ap (2)

Expression (2) is obtained based upon an assumption that the ratio of the variation of the color component q (standard deviation Sq) as to the variation of the color component p (standard deviation Sp) is the gradient αqp for the linear correlation shown in the aforementioned Expression 1, and furthermore, the straight line with the gradient αqp passes through the point plotted with the average Ap for the color component p and the average Aq for the color component q.

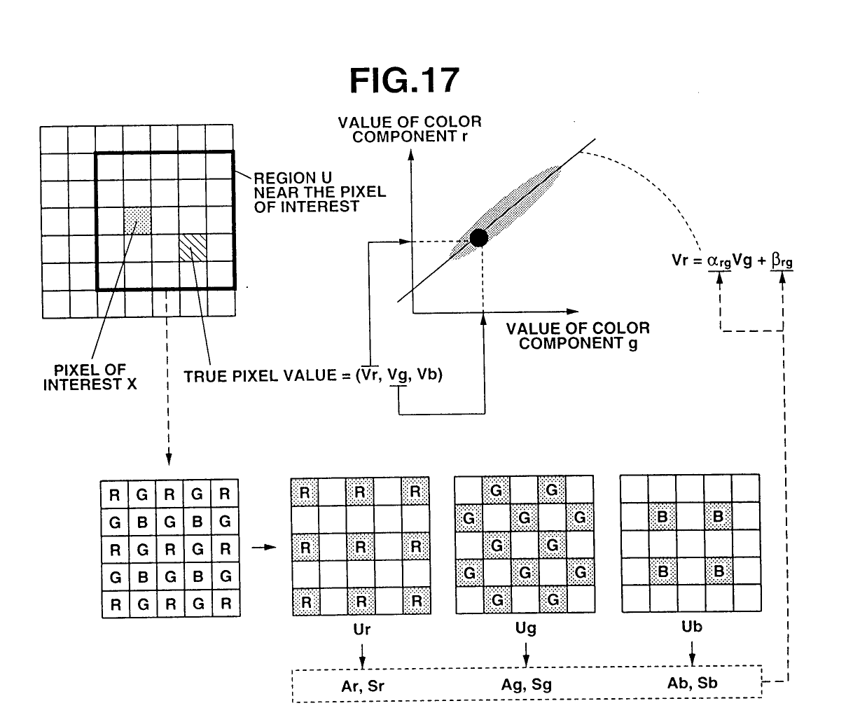

In this case, as shown in FIG. 18, the estimation values of the coefficients differs depending upon the position of the region U around the pixel of interest, and particularly, in the event that the region U contains color edges, estimation precision is greatly reduced.

Accordingly, multiple kinds of regions Uk are set around the pixel of interest, and the estimation values for each region Uk are weighted with the reliability estimated from the maximal value of the standard deviation in the Uk, or the like, so as to obtain the final estimation values αqp and βqp for color correlation with regard to the pixel of interest X, thereby obtaining the value Xm of the color component m, which is non-existent in the pixel of interest, from the value Xe of the color component e obtained in the pixel of interest X, based upon the estimated αqp and βqp using the above-described Expression 1, as shown in the following Expression 3.

Xm=αme·Xe+βme (3)

wherein m and e are one of r, g, and b respectively.

As described above, with the conventional technique based upon color correlation, correlation between pixel values of different color components is estimated near the pixel of interest, and the color component non-existent in the pixel of interest is generated from the color component obtained in the pixel of interest based upon the estimated correlation.

However, the above-described conventional technique based upon edge detection has no documentation describing a method wherein the pixel with the non-existent color component is suitably generated in the event that judgment cannot be made as to the edge direction due to the difference in the vertical direction and the difference in the horizontal direction being the same around the pixel of interest X, as shown in FIG. 16C.

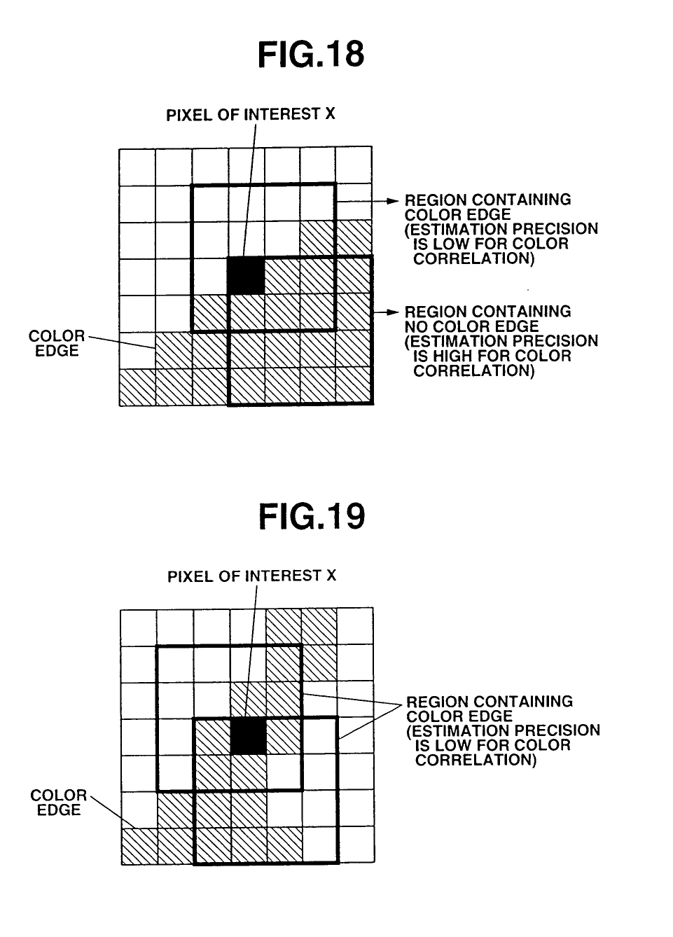

Also, the conventional technique based upon the above-described color correlation has no documentation describing a method wherein the pixel with the non-existent color component is suitably generated in the event that accurate estimation values for color correlation cannot be obtained due to color edges being contained no matter how the region near the pixel of interest X is set as shown in FIG. 19.

Furthermore, the means based upon edge detection has the nature of exhibiting great effects for the region containing clear edges, and on the other hand, the means based upon color correlation has the nature of exhibiting great effects for the texture region. However, either conventional technique has no documentation describing suitable means exhibiting great effects for both the region containing edges and the texture region.

Next, description will be made regarding a first embodiment according to the present invention.

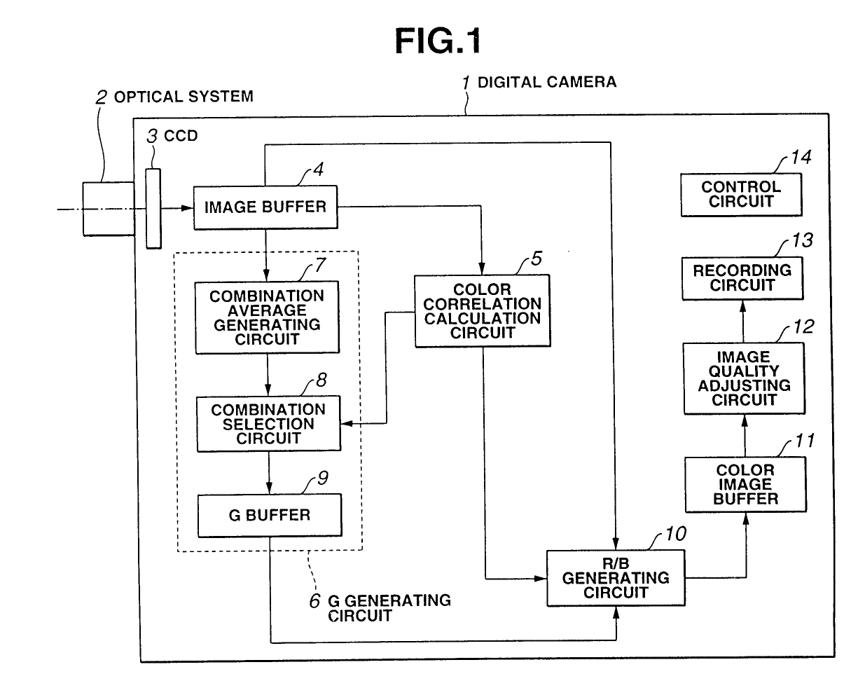

FIG. 1 is a block diagram which illustrates the configuration of a digital camera.

The first embodiment is applying an image processing device of this invention to digital cameras.

As shown in FIG. 1, the digital camera 1 comprises an optical system 2 for focusing a luminous flux from the subject, a single-chip CCD 3 having a primary-Bayer-array color filter for photo-electric-conversion of the subject image formed by the optical system so as to output image-pickup signals, an image buffer 4 for temporarily storing the digitized image data output from the CCD 3, and digitized by an unshown A/D converting circuit or the like, a color correlation calculation circuit 5 which is color estimation means for estimating the color correlation near the pixel of interest within the image, a G generating circuit 6 for estimating the G component of the pixel position where the G component has been dropped out, based upon the color correlation estimated by the aforementioned color estimation calculation circuit 5 for the image data stored in the aforementioned image buffer 4 so as to generate the G component image, an R/B generating circuit 10 for constructing the R component and the B component, which have been dropped out, so as to generate a three-primary-color image based upon the G component image generated by the G generating circuit 6, the image data stored in the aforementioned buffer 4, and the color correlation estimated by the aforementioned color correlation calculation circuit 5, a color image buffer 11 for temporarily storing the three-primary-color image generated by the R/B generating circuit 10, an image-quality adjusting circuit 12 for performing image-quality adjusting processing such as color conversion, edge enhancement, or the like, for a color image stored in the color image buffer 11, a recording circuit 13 for recording the data of the three-primary-color image subjected to image-quality adjustment by the image-quality adjusting circuit, and a control circuit 14 for centrally controlling the digital camera including the aforementioned circuits.

The aforementioned G generating circuit 6 comprises an combination average generating circuit 7 for generating averages for several combinations of G pixels around the pixel having no G component (pixel of interest) in the image data stored in the aforementioned image buffer 4, a combination selection circuit 8 which is combination selecting means for determining which of the combination averages generated by the combination average generating circuit 7 is used for the estimation value of the G component value non-existent in the pixel of interest based upon the calculation results from the aforementioned color correlation calculation circuit 5, and a G buffer 9 for storing a G component image obtained by generating the non-existent G components based upon the combinations determined by the combination selection circuit 8.

Description will be made regarding the operations of the digital camera 1 having the above-described configuration.

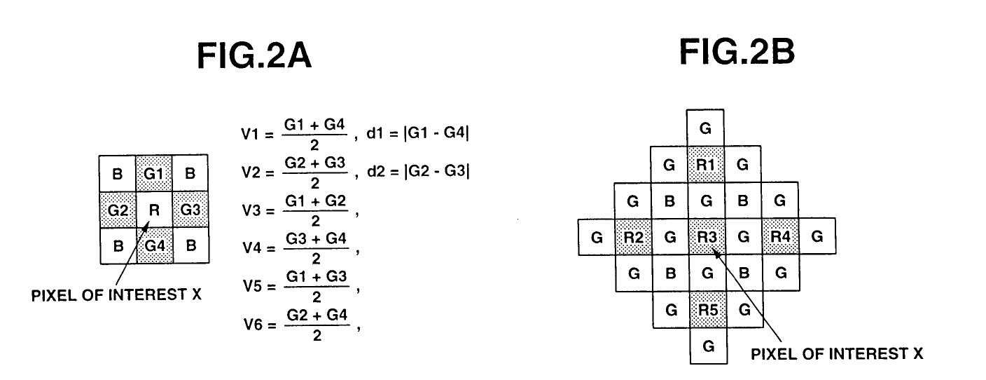

FIGS. 2A and 2B are diagrams which illustrate the region near the pixel of interest X used for the combination average generating circuit 7 and the color correlation calculation circuit 5, respectively.

Upon the user pressing an unshown shutter button, first of all, an optical image formed by the optical system 2 is taken by the aforementioned single-chip CCD 3 with the Bayer array, and an incomplete color image, wherein each pixel has only one color component, is stored in the image buffer 4.

Next, the combination average generating circuit 7 performs processing for each pixel of the image in the image buffer 4. In this case, the processing differs depending upon the kind of the color component obtained at the pixel of interest.

That is to say, in the event that the pixel of interest is the G pixel having the G component, the combination average generating circuit 7 writes the pixel value of the pixel of interest to the corresponding pixel position of the G buffer 9 as it is.

On the other hand, in the event that the pixel of interest is the R pixel having the R component or the B pixel having the B component, the combination average generating circuit 7 reads out the 3×3 pixel region centered on the pixel of interest (3×3 region near the pixel of interest) as shown in FIG. 2A, and calculates the six combination averages V1 through V6 for two G component values selected from the G component pixels at the upper, lower, left, and right position of the pixel of interest X at the center of the region, and the combination differences d1 and d2 (which are variables) for the combinations corresponding to aforementioned V1 and V2, as described below.

That is to say, with the pixel at the upper position of the pixel of interest X (R pixel in an example shown in FIG. 2A) as G1, with the pixel at the left position thereof as G2, with the pixel at the right position thereof as G3, with the pixel at the lower position thereof as G4, with the average for the upper and lower pixels as V1, with the average for the left and right pixels as V2, with the average for the upper and left pixels as V3, with the average for the right and lower pixels as V4, with the average for the upper and right pixels as V5, with the average for the left and lower pixels as V6, with the difference between the upper and lower pixels as d1, and with the difference between the left and right pixels as d2, the combination average generating circuit 7 performs calculation as shown in following Expression 4 and Expression 5, and outputs the results to the combination selection circuit 8.

V1=(G1+G4)/2

V2=(G2+G3)/2

V3=(G1+G2)/2

V4=(G3+G4)/2

V5=(G1+G3)/2

V6=(G2+G4)/2 (4)

d1=|G1−G4|

d2=|G2−G3| (5)

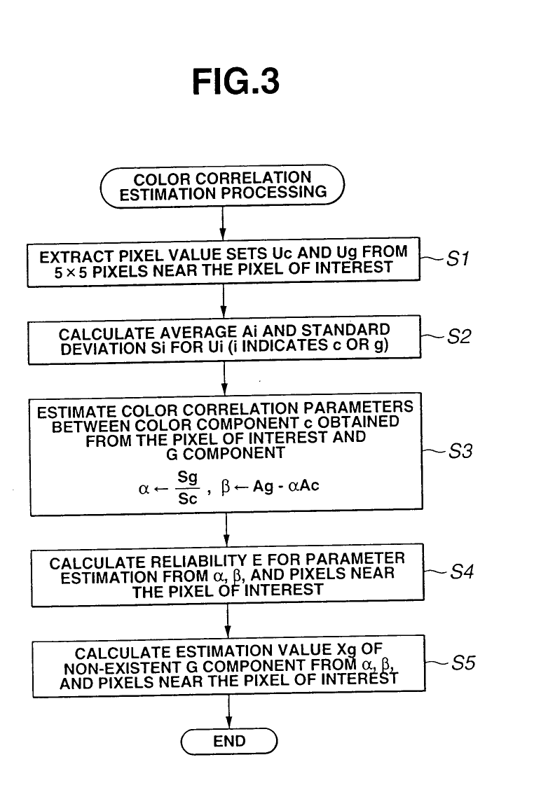

While the combination average generating circuit 7 performs the above-described operations, the color correlation calculation circuit 5 sets the diamond-shaped region U formed of 25 pixels centered on the pixel of interest X as shown in FIG. 2B, and calculates the color correlation necessary for estimating the G component of the pixel of interest in the same way disclosed in Japanese Unexamined Patent Application Publication No. 11-215512. FIG. 3 is a flowchart which indicates the color correlation estimation processing performed by the color correlation calculation circuit 5.

First of all, with the color component obtained in the pixel of interest X as c (which indicates r, g, or b), the pixels having the color component c (i.e., the same color component as the pixel of interest) are specified in the region U as shown in FIG. 2B so as to extract the pixel values of these pixels, thereby generating the set Uc of the pixel values of the color component c. Furthermore, the pixels having the G component are specified in the region U so as to extract the pixel values of these pixels, thereby generating the set Ug of the pixel values of the color component G (Step 1).

Next, the averages Ac and Ag, and the standard deviation Sc and Sg are calculated for the generated sets of the obtained pixel values Uc and Ug, respectively (Step 2).

Subsequently, a and P are calculated as parameters for the color correlation between the color component c and the G component within the region U based upon the aforementioned Expression 2 as represented with the following Expression 6 (Step 3).

α=Sg/Sc, β=Ag−α·Ac (6)

Subsequently, the reliability of the color correlation parameters calculated in Step S3 is evaluated. First of all, with the five R pixels R1 through R5, which are indicated by hatching within the region U near the pixel of interest as shown in FIG. 2B, the G components G1 non-existent in these five R pixels R1 through R5 are calculated from the color correlation parameters α and β using the following Expression 7.

G1=α·Ri+β (i=1 through 5) (7)

Subsequently, four kinds of differences between the G1 and the G component at the left and right positions of the pixel of interest, and at the positions upper and lower the pixel of interest, are calculated for each Ri so as to obtain the minimal difference Ei for each Ri.

Finally, the degree of reliability E which is a standard for the color correlation is obtained as the inverse number of the average of the differences Ei as represented with the following Expression 8.

E=1/Avg(Ei) (8)

Here, i indicates 1 through 5, and the function Avg represents averaging Ei. The greater the calculated degree of reliability E is, the better matching is obtained between the estimation result of the G component obtained based upon the color correlation and the G pixel values around the pixel, used for the estimation, and accordingly, judgment can be made that the estimation based upon the color correlation has succeeded (Step S4).

The non-existent G component estimation value Xg for the pixel of interest is calculated based upon the value Vc of the color component c obtained in the pixel of interest using the following Expression 9 (Step S5).

Xg=α·Vc+β (9)

Upon the above-described color correlation estimation processing ending, the non-existent G component estimation value Xg and the estimation degree of reliability E, obtained with the color correlation estimation processing, are output to the combination selection circuit 8.

At the point that the above-described processing ends, the combination selection circuit 8 has obtained the information with regard to the combination averages V1 through V6 and combination differences d1 and d2 for the G pixels around the pixel of interest, and the non-existent G component estimation value Xg and the degree of reliability E thereof based upon color correlation.

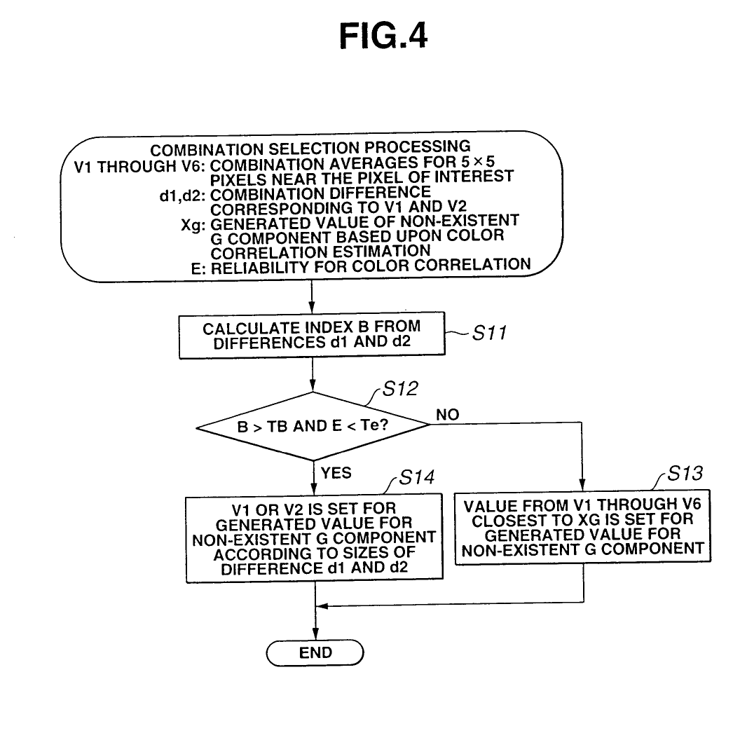

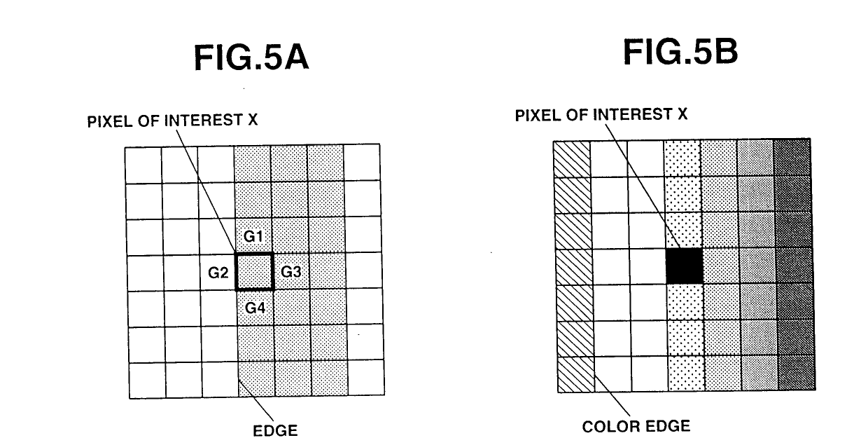

The combination selection circuit 8 generates the non-existent color component of the pixel of interest based upon the aforementioned information as shown in FIGS. 4, 5A, and 5B. FIG. 4 is a flowchart which indicates the combination selection processing performed by the combination selection circuit 8, and FIGS. 5A and 5B are diagrams for describing examples of the edge and the pixel value generated in the processing performed by the combination selection circuit 8.

First of all, the index B for indicating the presence or absence of the horizontal edge or vertical edge around the pixel of interest is obtained from the combination differences d1 and d2 using the following Expression 10 (Step 11).

B=|d1−d2|/(d1+d2) (10)

In the event that there is a clear edge on the pixel of interest in the horizontal or vertical direction, e.g., in a case as shown in FIG. 5A, in general, the change in the pixel value is small in the direction along the edge (the vertical direction passing through G1 and G4 in the example shown in the drawing), and the change in the pixel value is great in the direction orthogonal to the edge (the horizontal direction passing through G2 and G3 in the example shown in the drawing). As a result, with the combination differences d1 and d2, the difference between the G pixel combinations near the pixel of interest in the direction along the edge is small as compared with the difference between the G pixel combinations near the pixel of interest in the direction orthogonal to the edge. The obtained index B is a value for making judgment as to the presence or absence of the horizontal or vertical edge near the pixel of interest X based upon the above-described nature, that is to say, the closer to 1 the index B is, the higher the probability is that a clear edge exists in the horizontal or vertical direction.

Next, judgment is made whether or not the condition holds that the index B is greater than a predetermined threshold Tb and the degree of reliability E is less than a predetermined threshold Te (Step S12).

Here, in the event that the condition does not hold, judgment is made that there are no clear edges in the horizontal or vertical direction, or the reliability for the color correlation is great, independent of the presence or absence of clear edges. Accordingly, six kinds of differences ej between the non-existent G component estimation value Xg and the combination averages V1 through V6 are calculated as shown in the following Expression 11.

ej=|Xg−Vj| (11)

Here, j indicates an any integer among 1 to 6. The combination average Vj wherein the corresponding difference ej exhibits the minimal value is determined to be the final non-existent G component generated value (Step S13). As a result, the combination average Vj which is closest to the non-existent G component estimation value Xg is taken as the non-existent G component generated value.

On the other hand, in the event that the condition holds in the above-described Step S12, judgment is made that there are clear edges in the horizontal or vertical direction, so the reliability for the color correlation is not be excellent. In this case, the combination average Vj (j indicates 1 or 2) corresponding to the smaller one of the differences d1 and d2 is determined to be the final non-existent G component generated value (Step S14).

Thus, upon the final non-existent G component generated value being obtained in Step S13 or Step S14, the combination selection processing ends.

In general, in the event that the index B is a great value due to the presence of edges near the pixel of interest X in the horizontal or vertical direction, there is high probability that the average for the G pixels near the pixel of interest in the direction along the edge is closer to the true non-existent G component of the pixel of interest than the average for the G pixels near the pixel of interest in the direction orthogonal to the edge.

In a case as shown in FIG. 5A, the difference d1=|G1−G4| is a small value, and the difference d2=|G2−G3| is a great value, and accordingly, the combination average corresponding to the difference d1, V1=(G1+G4)/2, is a value closer to the true non-existent G component of the pixel of interest X than the combination average V2=(G2+G3)/2.

On the other hand, in the event that the region near the pixel of interest X does contain no edges in the horizontal or vertical direction, but contains edges in an oblique direction or in a texture region, the difference between the combination differences d1 and d2 is small, and accordingly, the index B exhibits a small value.

In this case, in the event that the degree of reliability E for estimation results for the color correlation within the region exhibits a high value, there is high probability that the non-existent G component estimation value Xg based upon the color correlation is close to the true non-existent G component of the pixel of interest. Note that the degree of reliability E is simply the reference for the reliability as to the estimation results, and accordingly, the degree of reliability E could be a great value even if the reliability in the estimation results is actually low. In this case, in the event of using the non-existent G component estimation value xg based upon the color correlation with low estimation precision for the generated value, the G component greatly different from the adjacent pixels is generated, and consequently, dot-shaped artifacts could be caused as shown in FIG. 5B. Accordingly, the final generated value is selected from the combination averages for the G pixels near the pixel of interest, so the estimation result is not greatly different from the pixels around the pixel of interest even in the event that the degree of reliability E is false to a certain degree as the index indicating the true reliability, and thus the dot-shaped artifacts do not readily occur.

The above-described processing is designed based upon the above-described consideration so as to obtain the final optimized non-existent generated value even in the event that the pixel of interest is on the edge region or the texture region.

Following such processing for the pixel of interest, upon the non-existent G component generated value being obtained, the combination selection circuit 8 writes the generated value to the corresponding pixel position in the G buffer 9.

Upon the series of processing described above being performed by the combination average generating circuit 7, the color correlation calculation circuit 5, and the combination selection circuit 8, for the pixels of all the pixels within the image buffer 4, the G component image wherein non-existence of the G components are generated for all the pixels is obtained in the G buffer 9.

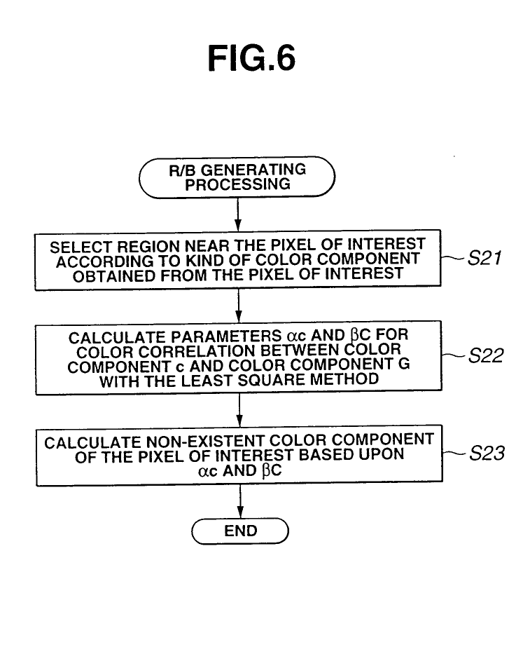

Thus, following the G component image wherein all the pixels have the G components being obtained, the R/B generating circuit 10 is operated. FIG. 6 is a flowchart which indicates the R/B generating processing performed by the R/B generating circuit 10.

Upon the R/B generating processing being started, a region with a predetermined size near the pixel of interest is read out for each pixel X of an image stored in the image buffer 4, and the G components are read out from the region near the corresponding pixel of interest stored in the aforementioned G buffer 9 (Step S21). The size of the region read out differs according to the kind of the color component of the pixel of interest X, that is to say, a region of 3×3 pixels is read out for the pixel having the R component or the B component, and a region of 4×4 pixels is read out for the pixel having the G component.

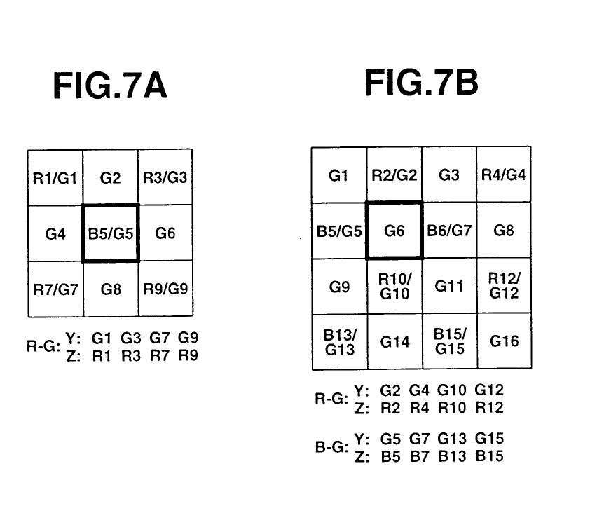

The data arrangements read out in the aforementioned cases are shown in FIGS. 7A and 7B. FIGS. 7A and 7B are diagrams which illustrates examples of the regions taken near the pixel of interest in the processing performed by the R/B generating circuit 10.

FIG. 7A illustrates an example in the event that the pixel of interest X has the color component B (B5 in the example shown in the drawing) obtained by the CCD 3 in image-taking, and at the point that processing is performed by the R/B generating circuit 10, the pixel of interest also has the color component G5 generated by the above-described G generating circuit 6. Note that in the event that the pixel of interest X has the color component R obtained by the CCD 3 in image-taking, the data arrangement is modified so as to interchange the B component with the R component in FIG. 7A.

On the other hand, FIG. 7B illustrates an example in the event that the pixel of interest X has the color component G (G6 in the example shown in the drawing) obtained by the CCD 3 in image-taking, and the region of 4×4 pixels near the pixel of interest is employed, which is somewhat large as compared with the case shown in FIG. 7A as described above. This is because in the event that a region of 3×3 pixels is set for the pixel having the G component obtained from the CCD 3, the region contains only two each of pixels having the R components and the B components.

Next, with the color component non-existent in the pixel of interest X being as the color component c, the color correlation between the color component c and the G component is estimated within the region read out. The G components are obtained for all the pixels within the region near the pixel of interest in the processing performed by the above-described G generating circuit 6, and accordingly, two kinds of the color components, i.e., the G components and the color components c, are obtained in the pixel positions having the color components c near the pixel of interest X, as shown in FIGS. 7A and 7B. Accordingly, in these pixel positions, with the G components as the data Y, and with the pixel values of the color components c as the data X, and making an assumption that the approximation relation Z=αc·Y+βc holds, the parameters for the relation αc and β are calculated with the known least square method. Furthermore, in the event that the color component obtained in the pixel of interest X is the G component, two kinds of the components, i.e., the R component and the B component are non-existent, so the above-described estimation is performed two times for the R component and the B component, thereby calculating the parameters αr and βr, and αb and βb (Step S22).

The computation (αc·Vg+βc) is performed using the approximation parameters αc and βc thus calculated, and the G component Vg of the pixel of the interest X, thereby estimating the pixel value of the color component c non-existent in the pixel of interest. At this time, in the event that the color component obtained in the pixel of interest is the G component, the computation is performed two times for the R component and the B component as to the c component shown in the aforementioned Expression (Step S23).

Upon such processing being performed for all the pixels of the image stored in the image buffer 4, the R/B generating processing ends, thereby obtaining tri-color components for all the pixels wherein one color component is the component obtained in image-taking, and the other two color components are the estimated components. The tri-color image thus obtained is stored in the color image buffer 11.

The color image stored in the color image buffer 11 is subjected to color conversion, contrast adjustment, edge enhancement, or the like, by the image quality adjusting circuit 12, and subsequently, is compressed by the recording circuit 13 so as to record on a recording medium or the like.

Note that the present embodiment is not restricted to the above-described arrangement, but rather, various modifications may be made.

For example, while description has been made regarding the arrangement wherein the combination averages are obtained only for the G component, and following the all the non-existent G components being generated, the R components and B components are obtained based upon color correlation, an arrangement may be made wherein the non-existent color components are generated by selecting from the combination averages near the pixel of interest for the R components and the B components in the same way as with the G components.

Furthermore, while description has been made regarding the arrangement wherein the combination average is obtained from the combination of two pixels from the pixels near the pixel of interest, an arrangement may be made wherein the combination averages and the combination differences are obtained from the combination of three or more pixels from the pixels near the pixel of interest.

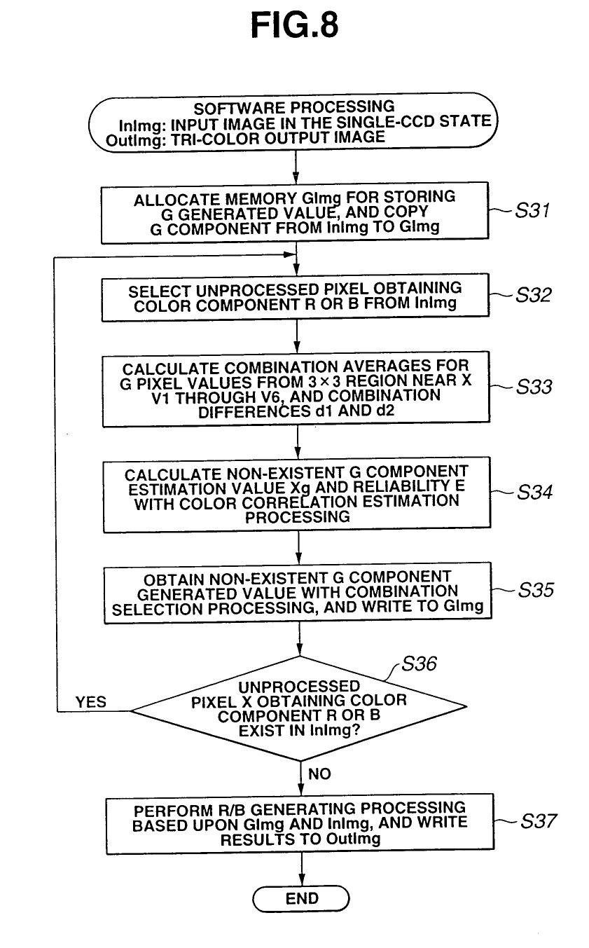

Furthermore, while description has been made regarding the arrangement wherein processing is performed by the hardware inside the digital camera 1 serving as an image processing device, an arrangement easily can be made wherein such processing is performed on a computer such as a PC (personal computer) or the like with an image processing program. FIG. 8 is a flowchart which indicates software processing performed by the computer.

With the software processing performed by the image processing program, an image InImg having only one color component at each pixel is input, and a tri-color image OutImg is generated and output. Let us say that these memory regions have been prepared for the processing beforehand. At this time, the memory region for the InImg corresponds to the image buffer 4 in the hardware shown in FIG. 1, and the memory region for the OutImg corresponds to the color image buffer 11 in the hardware shown in FIG. 1.

Upon the processing being started, first of all, the memory region for using as the buffer GImg for generating G component (corresponding to the G buffer 9 in the hardware shown in FIG. 1) is allocated. Subsequently, the pixel values of the pixels having the G components in the image InImg are copied to the corresponding pixel positions in the GImg without change (Step S31).

Next, one of the unprocessed pixels having the R component or the B component in the image InImg is selected as the pixel of interest X (Step S32).

Subsequently, the combination averages V1 through V6, and the combination differences d1 and d2 corresponding V1 and V2 are calculated for the pixels having the G component contained in the region of 3×3 pixels near the pixel of interest, as shown in FIG. 2A described above (Step S33).

Subsequently, the region U near the pixel of interest is set as shown in FIG. 2B described above, and the color correlation estimation processing is performed as shown in FIG. 3 described above, thereby calculating the non-existent G component estimation value Xg and the degree of reliability E for the estimation based upon color correlation estimation (Step S34).

Subsequently, the combination selection processing as shown in FIG. 4 described above is performed, and the non-existent G component generated value is calculated for the pixel of interest, whereby the calculation result is written to the corresponding pixel position in the GImg (Step S35).

Judgment is made as to whether there are any unprocessed pixels having the R component or the B component in the image InImg (Step S36), and in the event that there are any, the flow returns to the processing in Step S32 described above, and the processing as described above is repeatedly performed.

On the other hand, in the event that there are no unprocessed pixels, the R/B generating processing as described in FIG. 6 is performed based upon the GImg and InImg so as to generate the non-existent color component other than the G component for each pixel, and the generated result is written to the corresponding pixel position in the OutImg (Step S37), whereby the processing ends.

Note that while description has been made regarding an arrangement employing a single-sensor image-pickup system including primary-color Bayer-array color filters, an arrangement may be made wherein a single-sensor image-pickup system including complementary-color-Bayer-array color filters or other color filters are employed. Furthermore, it is needless to say that the above-described configuration can be applied to an arrangement wherein a digital image obtained from the two-sensor image-pickup system or the triple-sensor pixel spatial offset image-pickup system wherein one or more color components are non-existent for each pixel is subjected to estimation for the non-existent components for each pixel so as to be output as a color digital image.

In a case that the reliability for the color correlation estimation results is low, in the event that the non-existent color component estimation is performed based upon the estimation results, dot-shaped artifacts could occur. However, with the first embodiment described above, the plural combination averages for the pixel values near the pixel of interest are generated by the combination average generating circuit 7 for multiple combinations, one value is selected from these combination averages by the combination selection circuit 8 based upon the color correlation estimation results so as to be determined to be the non-existent color component, and accordingly, matching is improved between the generated non-existent component in the pixel of interest and the pixels therearound, and thus the artifacts are hardly caused.

Furthermore, with the present embodiment, in the event that the reliability for the color correlation estimation results is great, the combination average is selected based upon the estimated color correlation, the non-existent color component can be generated with high precision as compared with simple linear interpolation or the like.

Furthermore, with the present embodiment, the reliability for the color correlation estimation results is evaluated, and in the event that the reliability is great, the combination average close to the non-existent component candidate calculated based upon color correlation is selected, and thus, the non-existent color component can be estimated with excellent precision in the texture region or the like.

On the other hand, in the event that the reliability for the color correlation estimation results is low, the combination average corresponding to the combination wherein the minimal fluctuation has been calculated by the combination average generating circuit 7 is selected as the non-existent color component by the combination selection circuit 8, thereby enabling the non-existent component to be estimated with excellent precision even for the edge region which reduces the reliability for the color correlation estimation results.

Next, description will be made regarding a second embodiment according to the present invention.

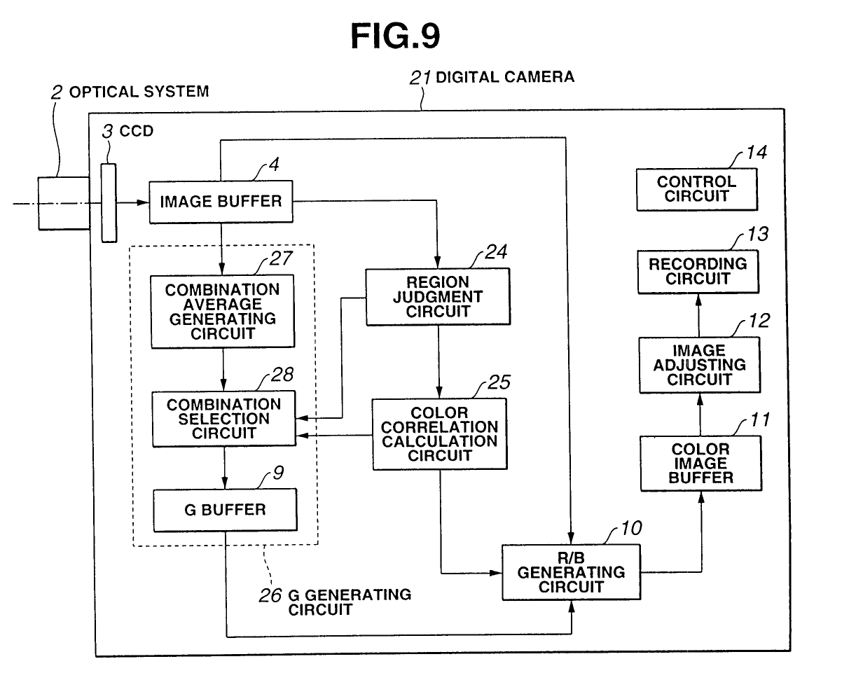

FIG. 9 is a block diagram which illustrates a configuration of a digital camera of a second embodiment.

With the second embodiment, description will be omitted with regard to the same components as with the above-described first embodiment, the same component are denoted with the same reference characters as with the first embodiment, and description will be primarily made only regarding the differences.

With this second embodiment, the image processing device of the present invention is applied to the digital camera in the same way as with the above-described first embodiment.

A digital camera 21 of the present second embodiment further comprises a region judgment circuit 24 serving as evaluation means and also region judgment means as compared with the digital camera 1 according to the above-described first embodiment, and so the operations are different in a combination average generating circuit 27 serving as a first non-existent color component estimation means in a G generating circuit 26, a color correlation calculation circuit 25 serving as a second non-existent color estimation means, and a combination selection circuit 28 serving as a third non-existent color estimation means in the G generating circuit 26.

The operations of the entire digital camera 21, from an unshown shutter button being pressed by the user up to the obtained image in the single-plate state being stored in the image buffer 4, are the same as with the above-described first embodiment.

Next, the combination average generating circuit 27 performs processing for each pixel of the image in the image buffer 4. Here, in the event that the pixel of interest has the color component G, the processing for the pixel of interest is the same as with the above-described first embodiment.

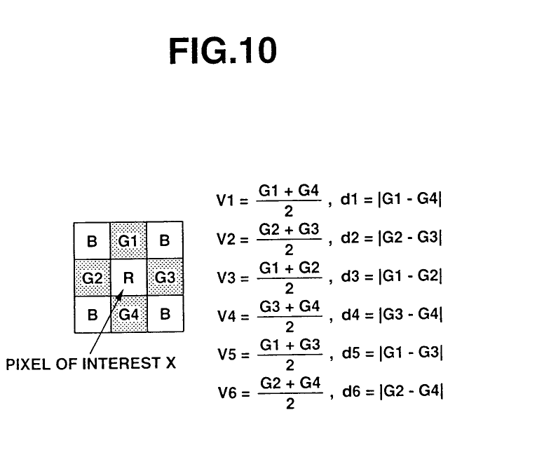

On the other hand, in the event that the pixel of interest has the R component or B component, the operations are somewhat different from those of the above-described first embodiment. That is to say, the combination average generating circuit 27 reads out a 3×3 region near the pixel of interest, calculates six kinds of the combination averages V1 through V6, and the differences between the corresponding combinations d1 through d6 for the G components obtained at the left and right positions of the pixel of interest X which is a center of the region, and at the upper and lower positions of the pixel of interest, as shown in FIG. 10, and outputs these results to the combination selection circuit 28.

The processing performed in parallel with the above-described processing performed by the combination average generating circuit 27 is somewhat different from that of the above-described first embodiment.

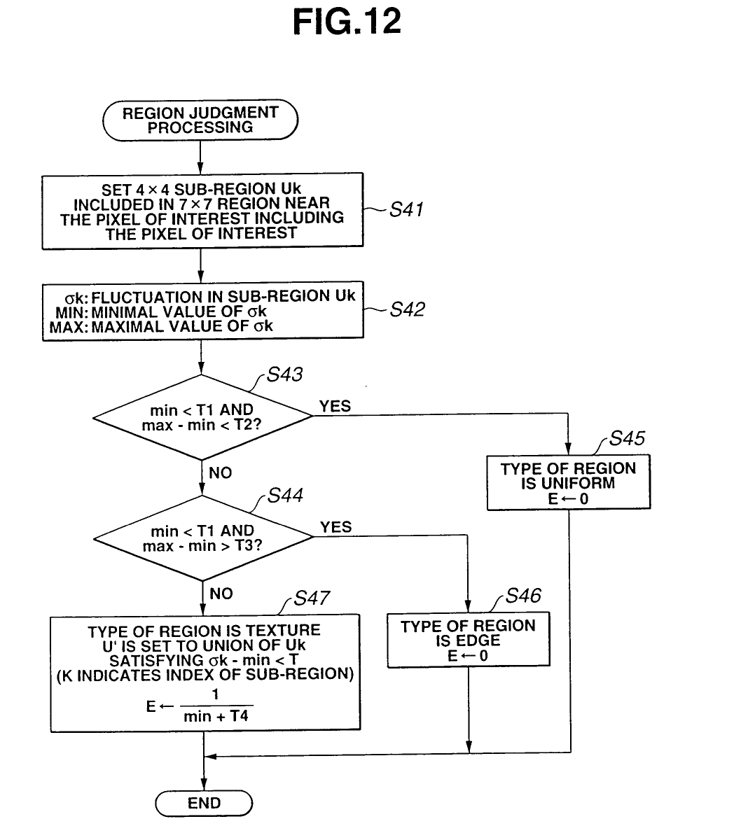

First of all, following the flowchart as shown in FIG. 12, the region judgment circuit 24 judges the type of the region, i.e., whether or not the region of interest is an edge region, or whether or not the region of interest is a texture region, and calculates the predicted degree of reliability E for color correlation estimation in the region, according to the type of the region.

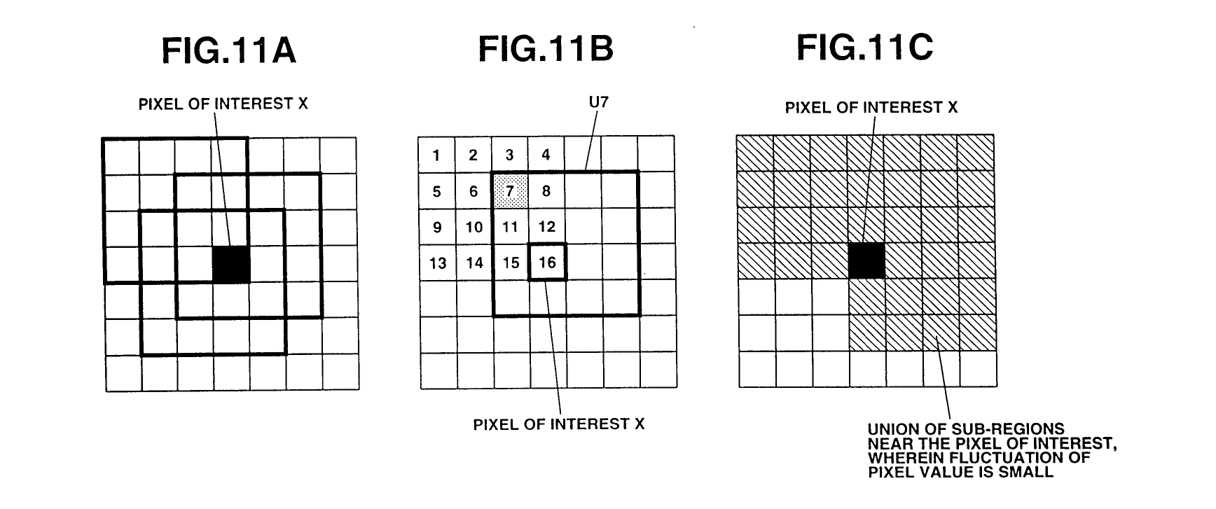

Description will be made below regarding each step shown in the flowchart in FIG. 12 with reference to FIGS. 11A, 11B, 11C, or the like, as necessary. FIGS. 11A, 11B, and 11C are diagrams which illustrate the region near the pixel of interest used by the region judgment circuit 24, and FIG. 12 is a flowchart which indicates region judgment processing performed by the region judgment circuit 24.

As shown in FIG. 11A, a 7×7 pixel region centered on the pixel of interest is taken around the pixel of interest X, and furthermore, a 4×4 pixel sub-region is taken inside the 7×7 pixel region as indicated with the bold frame shown in FIG. 11A (Step S41). Sixteen kinds of the sub-regions can be taken according to the pixel position selected to be the pixel of interest X within the 4×4 pixel sub-region. Accordingly, let us say that the upper-left pixels of the sixteen kinds of sub-regions, which can be taken for the 7×7 regions, are denoted by the reference numerals 1 through 16 as shown in FIG. 11B, and the sub-regions will be referred to as U1 through U16 using the reference numerals. For example, in FIG. 11B, the upper-left pixel of the sub-region is at the seventh position, so the sub-region will be referred to as “sub-region U7”.

The standard deviation σk of the G components obtained within the sub-region is calculated for each sub-region Uk (k is 1 through 16), and the minimal value min and the maximal value max for the standard deviation σk are calculated (Step S42).

Subsequently, the type of the region near the pixel of interest is classified based upon these minimal value min and maximal value max as shown in following Steps S43 and S44. Note that T1 through T3 shown in Steps S43 and S44 are predetermined thresholds.

With classification of the type of the region, first of all, judgment is made whether or not the relations min<T1 and max−min<T2 hold with regard to the minimal value min and the maximal value max obtained in the above-described Step S42 (Step S43).

In the event that the relations hold, judgment is made that the region is uniform, and the degree of reliability E is set to 0 (Step S45), whereby the processing ends.

Conversely, in the event that the relations do not hold in the aforementioned Step S43, judgment is further made whether or not the relations min<T1 and max−min>T3 hold (Step S44).

In the event that the relations holds in Step S44, judgment is made that the region is an edge region, and the reliability is set to 0 (Step S46), whereby the processing ends.

Conversely, in the event that the relations do not hold in the above-described Step S44, judgment is made that the region is a texture region. In this case, first of all, each sub-region Uk is classified based upon the condition whether or not the relation σk−min<T4 holds. Here, T4 represents a predetermined threshold, and in the event that the condition is satisfied, the sub-region Uk can be regarded as being relatively uniform. Subsequently, the union U′ of the sub-regions Uk satisfying the condition is generated.

An example of the U′ thus generated is shown in the hatched region in FIG. 1C. Furthermore, the degree of reliability E is calculated using (min+T4) which indicates the maximal value of the standard deviation for the U′ as represented by the following Expression 12 (Step S47), whereby the processing ends.

E=1/(min+T4) (12)

Following such region judgement processing being performed, the region judgment circuit 24 outputs the degree of reliability E to the combination selection circuit 28, and in the event that the degree of reliability E is not 0, the region judgment circuit 24 further outputs the coordinates of the pixels contained in the U′ generated in Step S47, to the color correlation calculation circuit 25. Conversely, in the event that the degree of reliability E is 0, the region judgment circuit 24 does not output the coordinates to the color correlation calculation circuit 25, and estimation of the color correlation is not performed for the pixel of interest X.

In the event that the coordinates are input from the region judgment circuit 24, the color correlation calculation circuit 25 estimates the color correlation necessary for generating the G component of the pixel of interest in the same way as with the above-described first embodiment. Note that the shape of the region near the pixel of interest is not restricted to the shape as shown in FIG. 2B described above, and evaluation of the reliability for the color correlation is not performed, unlike the above-described first embodiment.

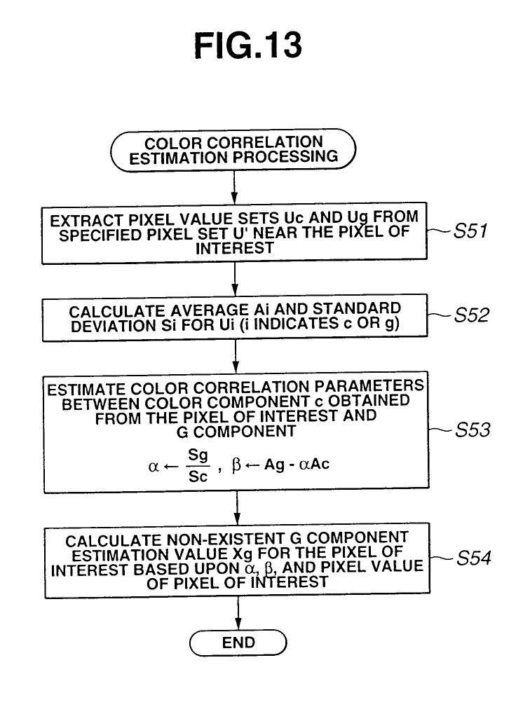

FIG. 13 is a flowchart which indicates color correlation estimation processing performed by the color correlation calculation circuit 25.

Upon the color correlation estimation processing being started, the pixel sets Uc and Ug are extracted from the pixel set U′ near the pixel of interest (Step S51). The region used at this time is not the region U indicated in FIG. 2B described above, but the region U′ formed of coordinates specified by the region judgment circuit 24, unlike the processing in step S1 shown in FIG. 3, and other processing is the same as with Step S1.

The subsequent processing of Steps S52, S53, and S54, are the same as with Steps S2, S3, and S5, in FIG. 3 for the above-described first embodiment, respectively. Upon the processing in Step S54 ending, the color correlation estimation processing ends.

Upon the color correlation estimation processing ending, the color correlation calculation circuit 25 outputs only the non-existent G component estimation values Xg, to the combination selection circuit 28.

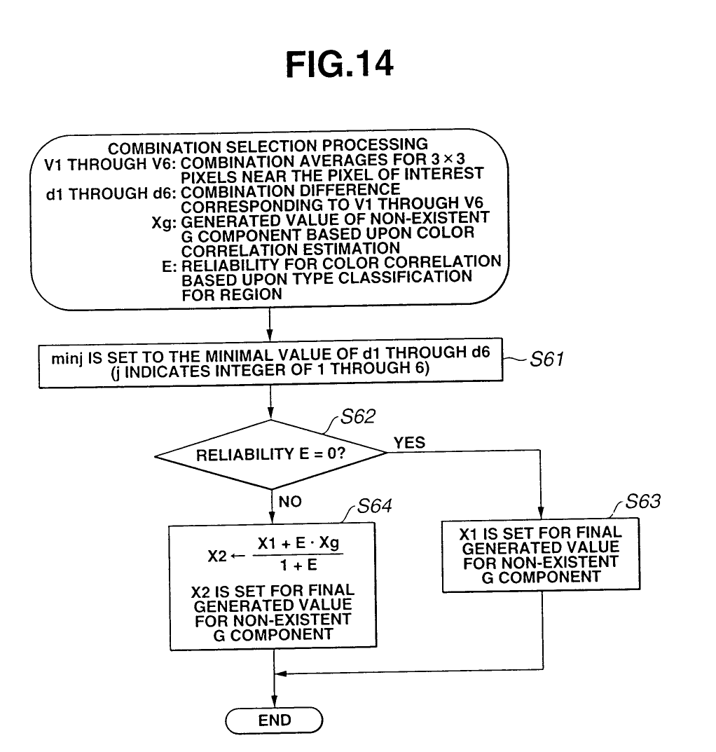

The degree of reliability E is input to the combination selection circuit 28 from the region judgment circuit 24, not from the color correlation calculation circuit 25, unlike the above-described first embodiment. FIG. 14 indicates operations for the pixel of interest following data being input from the combination average generating circuit 27 and the color correlation calculation circuit 25.

FIG. 14 is a flowchart which illustrates combination selection processing performed by the combination selection circuit 28.

First of all, the index j (which is an integer between 1 to 6), wherein the combination difference dj exhibits the minimal value of d1 through d6, is taken as minj, and the combination average vminj is taken as the first non-existent G component generated value X1 (Step S61).

Next, judgment is made whether or not the degree of reliability E is 0 (Step S62), in the event that the degree of reliability E is 0, the obtained X1 is determined to be the final non-existent G component generated value (Step S63).

Conversely, in the event that the degree of reliability E is not 0 in the above-described Step S62, the weighted average is calculated for X1 and the non-existent component estimation value Xg based upon the degree of reliability E thereof, thereby obtaining the final non-existent generated value X2, as represented with the following Expression 13 (Step S64).

X2=(X1+E·Xg)/(1+E) (13)

Upon the combination selection circuit 28 obtaining the final non-existent G component generated value for the pixel of interest X following the processing ending, the combination selection circuit 28 writes the generated result to the corresponding address in the G buffer 9.

The subsequent operations performed by other circuits are the same as with the above-described first embodiment.

Note that with the present embodiment, various modifications may be made, as well. For example, an arrangement may be made wherein the judgment whether or not the region is a texture region by the region judgment circuit 24 is performed using known texture analysis means.

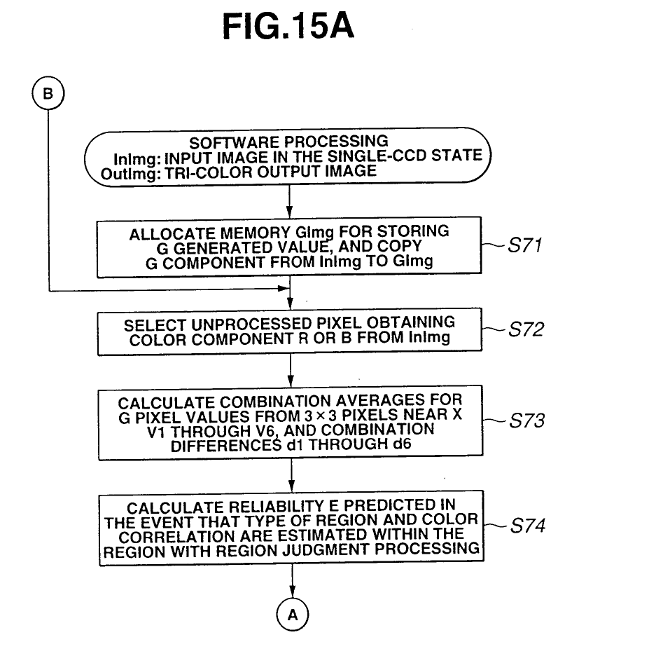

Furthermore, while description has been made regarding the arrangement wherein processing is performed by the internal hardware in the digital camera 21 serving as an image processing device, an arrangement may be easily made wherein such processing is performed by an image processing program on a computer such as a PC (personal computer). FIGS. 15A and 15B are flowcharts which illustrate the software processing performed by the computer.

With the software processing performed by the image processing program, an image InImg having one color component at each pixel is input, and a tri-color image OutImg is generated and output, in the same way as with the software processing of the first embodiment described above.

The processing shown in Steps S71, S72, S78, and S79, in the flowchart, is the same as the processing shown in Steps S31, S32, S36, and S37, respectively, so description will be made only regarding the processing in other Steps.

Upon the processing in Step S72 ending, the combination averages V1 through V6, and the combination differences d1 through d6, for the pixels having the G components within the region of 3×3 pixels near the pixel of interest X are calculated, as shown in FIG. 10 (Step S73).

Subsequently, the region judgment processing as shown in FIG. 12 described above is performed so as to judge the type of the region, thereby calculating the predicted degree of reliability E in case of the estimation of the color correlation within the region and calculating the sub-region U′ with relatively high uniformity within the region (Step S74).

Subsequently, judgment is made whether or not the degree of reliability E is 0 (step S75), and in the event that the degree of reliability E is not 0, the color correlation estimation processing as shown in FIG. 13 described above is performed for the region U around the pixel of interest, set in Step S74, thereby calculating the non-existent G component estimation value Xg based upon the color correlation estimation (Step S76).

Conversely, in the event that the degree of reliability E is 0 in Step S75 described above, or the processing in Step S76 described above ends, the combination selection processing shown in FIG. 14 described above is performed so as to calculate the non-existent G component generated value for the pixel of interest, and writes to the corresponding pixel position in GImg (Step S77), whereby the flow proceeds to the above-described Step S78.

With the above-described second embodiment, the same general effects can be obtained as with the above-described first embodiment, and also, based upon the evaluation results by the region judgment circuit 24 for the degree of reliability of the color correlation, the combination selection circuit 28 calculates the weights for the combination average obtained by the combination average generating circuit 27 and for the non-existent color component estimation value obtained by the color estimation calculation circuit 25 based upon color correlation, thereby enabling the non-existent color component to be estimated with high precision without artifacts regardless of the reliability of the color correlation.

Furthermore, judgment whether or not the region near the pixel of interest is a texture is employed by the region judgment circuit 24 for the evaluation standard for the evaluation means. Accordingly, in the event that the region is a texture region wherein the non-existent color component can be generated with high precision based upon color correlation, the estimation based upon the color correlation has larger effect on generating the non-existent value. Conversely, in the event that the region is an edge region wherein the non-existent color component can be generated with low precision based upon color correlation, the estimation based upon the color correlation has smaller effect on generating the non-existent value. Thus, with the present embodiment, non-existent color components can be estimated with excellent precision for any type of the region near the pixel of interest.

As described above, with the image processing device and the image processing program according to the present invention, the non-existent component of each pixel of a digital image wherein one or more color components are non-existent in each pixel can be more suitably estimated, thereby generating a color digital image.

Note that the present invention also encompasses modifications and the like, configured by partially combining the above-described embodiments or the like, as well.

In this invention, it is apparent that working modes different in a wide range can be formed on this basis of this invention without departing from the spirit and scope of the invention. This invention is not restricted by any specific embodiment except being limited by the appended claims.

What is claimed is:

1. An image processing device comprising:
input means for inputting an digital image wherein one or more color components are non-existent in each pixel, obtained from a single-sensor image-pickup system, a double-sensor image-pickup system, or a triple-sensor pixel spatial offset image-pickup system;
combination average calculation means for making a combination of two or more pixels from a plurality of pixels having the same color component near the pixel of interest within the image signals input from the input means, and calculating the average for the combination of the color components of two or more pixels for a plurality kinds of combinations of pixels in the region near the pixel of interest;
color correlation estimation means for estimating color correlation which is a correlation between different color components within the region near the pixel of interest; and
combination selection means for selecting one of the plurality of combination averages calculated by the combination average calculation means, as the non-existent color component for the pixel of interest, based upon the color correlation estimated by the color correlation estimation means.

2. The image processing device according to claim 1, wherein the combination average calculation means further calculates the fluctuation of the color component within the combination of two or more pixels;
and wherein the color correlation estimation means further calculates the reliability of the estimated color correlation;
and wherein, in the event that the reliability calculated by the color correlation estimation means is high, the combination selection means estimates the non-existent color component for the pixel of interest based upon the estimation results of the color correlation and the color component obtained in the pixel of interest, and selects the combination average which is the closest to the estimated non-existent color component candidate as the non-existent color component, and in the event that the reliability is low, the combination selection means selects the combination average corresponding to the combination wherein the fluctuation of the color component calculated by the combination average calculation means is the least, as the non-existent color component.

3. An image processing device comprising:
input means for inputting an digital image wherein one or more color components are non-existent in each pixel, obtained from a single-sensor image-pickup system, a double-sensor image-pickup system, or a triple-sensor pixel spatial offset image-pickup system;
first non-existent color component generating means for making a combination of two or more pixels from a plurality of pixels having the same color component near the pixel of interest within the image signals input from the input means, calculating the average for the combination the color components of two or more pixels for a plurality kinds of combinations in the region near the pixel of interest, and selecting one of the calculated averages so as to generate the non-existent color component;
second non-existent color component generating means for estimating the color correlation which is a correlation between different kinds of color components near the pixel of interest for each pixel, and generating the non-existent color component based upon the estimated color correlation and the color component obtained in each pixel;
evaluation means for evaluating the reliability of the color correlation estimated by the second non-existent color component estimation means; and
third non-existent color component generating means for setting the weight as to the non-existent color component generated by the second non-existent color component generating means based upon the reliability evaluated by the evaluation means, and calculating the weighted average for the non-existent color component generated by the first non-existent color generating means and the non-existent color component generated by the second non-existent color component generating means using the set weight, thereby generating the non-existent color component value.

4. The image processing device according to claim 3, further comprising region judgment means for making judgment whether or not the region near the pixel of interest is a texture region, and also making judgment whether or not the region near the pixel of interest is an edge region, wherein in the event that judgment is made by the region judgment means that the region is a texture region, the evaluation of the reliability is increased, and conversely in the event that judgment is made that the region is an edge region, the evaluation of the reliability is decreased.

5. An image processing program for inputting an digital image wherein one or more color components are non-existent in each pixel, obtained from a single-sensor image-pickup system, a double-sensor image-pickup system, or a triple-sensor pixel spatial offset image-pickup system, estimating the non-existent color component for each pixel so as to output a color digital image, the program comprising:
step for combination average calculation processing for making a combination of two or more pixels from a plurality of pixels having the same color component near the pixel of interest, and calculating the average for the combination of the color components of two or more pixels for a plurality kinds of combinations of pixels in the region near the pixel of interest;
step for color correlation estimation processing for estimating color correlation which is a correlation between different color components within the region near the pixel of interest; and
step for combination selection processing for selecting one of the plurality of combination averages calculated by the combination average calculation processing, as the non-existent color component for the pixel of interest, based upon the color correlation estimated by the color correlation estimation processing.

6. The image processing program according to claim 5, wherein the combination average calculation processing further includes processing for calculating the fluctuation of the color component within the combination of two or more pixels;
and wherein the color correlation estimation processing further includes for calculating the reliability of the estimated color correlation;
and wherein in the event that the reliability calculated by the color correlation estimation processing is high, the combination selection processing estimates the non-existent color component candidate for the pixel of interest based upon the estimation results of the color correlation and the color component obtained in the pixel of interest, and selects the combination average which is the closest to the estimated non-existent color component candidate as the non-existent color component, and in the event that the reliability is low, the combination selection processing selects the combination average corresponding to the combination wherein the fluctuation of the color component calculated by the combination average calculation processing is the least, as the non-existent color component.

7. An image processing program for inputting an digital image wherein one or more color components are non-existent in each pixel, obtained from a single-sensor image-pickup system, a double-sensor image-pickup system, or a triple-sensor pixel spatial offset image-pickup system, estimating the non-existent color component for each pixel so as to output a color digital image comprising:
step for first non-existent color component generating processing for making a combination of two or more pixels from a plurality of pixels having the same color component near the pixel of interest, calculating the average for the combination of the color component values of two or more pixels for a plurality kinds of combinations of pixels in the region near the pixel of interest, and selecting one of the calculated averages so as to generate the non-existent color component;
step for second non-existent color component generating processing for estimating the color correlation which is a correlation between different kinds of color components near the pixel of interest for each pixel, and generating the non-existent color component based upon the estimated color correlation and the color component obtained in each pixel;
step for evaluation processing for evaluating the reliability of the color correlation estimated by the second non-existent color component estimation processing; and
step for third non-existent color component generating processing for setting the weight as to the non-existent color component generated by the second non-existent color component generating processing based upon the reliability evaluated by the evaluation processing, and calculating the weighted average for the non-existent color component generated by the first non-existent color generating processing and the non-existent color component generated by the second non-existent color component generating processing using the set weight, thereby generating the non-existent color component value.

8. The image processing program according to claim 7, further comprising region judgment processing for making judgment whether or not the region near the pixel of interest is a texture region, and also making judgment whether or not the region near the pixel of interest is an edge region, wherein in the event that judgment made by the region judgment processing is that the region is a texture region, the evaluation of the reliability is increased, and conversely in the event that judgment is made that the region is an edge region, the evaluation of the reliability is decreased.
